(19) United States
(12) Patent Application Publication
(10) Pub. No.: US 2007/0228973 A1
(43) Pub. Date: Oct. 4, 2007

(54) Plasma display panel (PDP)

(76) Inventors: Hyun Soh, Suwon-si (KR); Se-Jong Kim, Suwon-si (KR); Yun-Hee Kim, Suwon-si (KR); Hyun Kim, Suwon-si (KR)

Correspondence Address: Robert E. Bushnell, Suite 300, 1522 K Street, N.W., Washington, DC, 20005-1202, US

(21) Appl. No.: 11/723,702

(22) Filed: Mar. 21, 2007

(30) Foreign Application Priority Data
Mar. 28, 2006 (KR) 10-2006-0028119

(51) Int. Cl. H01J 17/49

(52) U.S. Cl. 313/584; 313/585

(57) ABSTRACT

A Plasma Display Panel (PDP) includes: a first substrate and a second substrate facing each other; a barrier rib structure located between the first and second substrates to define a plurality of discharge cells; pairs of sustain electrodes arranged on the first substrate so as to face the second substrate and so that the sustain electrodes in each pair are spaced apart from one another, each pair of sustain electrodes including an X electrode and a Y electrode, a distance between the X and Y electrodes being greater than a height of the barrier rib structures; a plurality of auxiliary electrodes protruding from the respective sustain electrodes in each pair of sustain electrodes toward the other sustain electrode of the pair of sustain electrodes; and a first dielectric layer covering the pairs of the sustain electrodes and the auxiliary electrodes, the first dielectric layer including at least two grooves formed in each of the discharge cells, the two grooves corresponding to the X and Y electrodes.

### CLAIM OF PRIORITY

This application makes reference to, incorporates the same herein, and claims all benefits accruing under 35 U.S.C.§119 from an application for PLASMA DISPLAY PANEL earlier filed in the Korean Intellectual Property Office on the 28 Mar. 2006 and there duly assigned Serial No. 10-2006-0028119.

### BACKGROUND OF THE INVENTION

1. Field of the Invention

The present invention relates to a Plasma Display Panel (PDP), and more particularly, the present invention relates to a PDP with improved luminous efficiency.

2. Description of the Related Art

Plasma Display Panels (PDPs), which are considered to be potential replacements for conventional Cathode Ray Tubes (CRTs), are flat display panel devices in which a discharge gas is sealed between two substrates having a plurality of electrodes, a discharge voltage is supplied between the two substrates, and ultraviolet rays generated by supplying the discharge voltage excite phosphors, which are formed in a predetermined pattern, to obtain a desired image.

It is very important to design a PDP such that it can achieve a high luminous efficiency while operating with a voltage less than a predetermined firing voltage.

### SUMMARY OF THE INVENTION

The present invention provides a Plasma Display Panel (PDP) that can achieve improved luminous efficiency while operating with a voltage less than a predetermined firing voltage.

According to an aspect of the present invention, a Plasma Display Panel (PDP) is provided including: a first substrate and a second substrate facing each other; a barrier rib structure arranged between the first and second substrates to define a plurality of discharge cells; pairs of sustain electrodes arranged on the first substrate so as to face the second substrate and so that the sustain electrodes in each pair are spaced apart from one another, each pair of the sustain electrodes including an X electrode and a Y electrode, wherein a distance between the X and Y electrodes is greater than a height of the barrier rib structure; a plurality of auxiliary electrodes protruding from the respective sustain electrodes in each pair of sustain electrodes toward the other sustain electrode of the pair of sustain electrodes; and a first dielectric layer covering the pairs of sustain electrodes and the auxiliary electrodes, the first dielectric layer including at least two grooves formed in each of the discharge cells, the two grooves corresponding to the X and Y electrodes.

The barrier rib structure preferably includes: first partitions extending in parallel with the pair of the sustain electrodes; and second partitions connecting the first partitions to one another.

Each of the X and Y electrodes preferably includes a bus electrode and a transparent electrode arranged on the bus electrode, and each of the auxiliary electrodes preferably includes a protrusion arranged in parallel with either the bus electrode or the transparent electrode and an extension arranged on a respective second partition, the extension connecting the protrusion to either the bus electrode or the transparent electrode.

The protrusions of the auxiliary electrodes preferably face one another. The auxiliary electrodes are preferably alternately arranged on the second partitions. The protrusions of the auxiliary electrodes are preferably parallel to one another.

Each of the X and Y electrodes preferably includes a bus electrode and a transparent electrode arranged on the bus electrode, and each of the auxiliary electrodes preferably includes a protrusion arranged in parallel with either the bus electrode or the transparent electrode and a extension connecting the protrusion to either the bus electrode or the transparent electrode, either the bus electrode or the transparent electrode forming a closed loop together with the respective protrusion and extension. Each of the X and Y electrodes is preferably arranged to correspond to the first partitions. Each of the X and Y electrodes preferably includes a bus electrode and a transparent electrode arranged on the bus electrode, the bus electrodes being arranged between the first partitions to correspond to the discharge cells.

The grooves are preferably arranged to correspond to the X and Y electrodes. The grooves preferably include a groove corresponding to the X electrode and a groove corresponding to the Y electrode in each discharge cell. The distance between the grooves is preferably equal to or greater than a distance between the X and Y electrodes, and is less than or equal to a distance between farthest ends of the X and Y electrodes.

Each of the X and Y electrodes preferably includes a bus electrode and a transparent electrode arranged on the bus electrode, the grooves being arranged to correspond to the transparent electrodes. Each of the X and Y electrodes preferably includes a bus electrode and a transparent electrode formed on the bus electrode, at least parts of the grooves being arranged to correspond to the bus electrodes. The grooves in each discharge cell are preferably symmetrical with respect to a plane perpendicular to the first substrate and equidistant from the X and Y electrodes in the discharge cell.

The PDP preferably further includes: address electrodes intersecting the pairs of the sustain electrodes, the address electrodes arranged on the second substrate; a second dielectric layer covering the address electrodes; and phosphor layers arranged in the discharge cells.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is an exploded perspective view of a three-electrode surface discharge AC PDP;

FIG. 2 is an exploded perspective view of a PDP according to an embodiment of the present invention;

FIG. 3 is a cross-sectional view of the PDP of FIG. 2, taken along the line III-III;

FIG. 4 is a layout of the locations of discharge cells, electrodes, and first and second grooves of the PDP of FIG. 2;

FIG. 5 is a layout of the locations of discharge cells, electrodes, and first and second grooves of a PDP according to another embodiment of the present invention; and

FIG. 6 is a layout of the locations of discharge cells, electrodes, and first and second grooves of a PDP according to yet another embodiment of the present invention.

### DETAILED DESCRIPTION OF THE INVENTION

Hereinafter, exemplary embodiments of the present invention are described in detail with reference to the accompanying drawings. Like reference numerals denote like elements throughout the drawings.

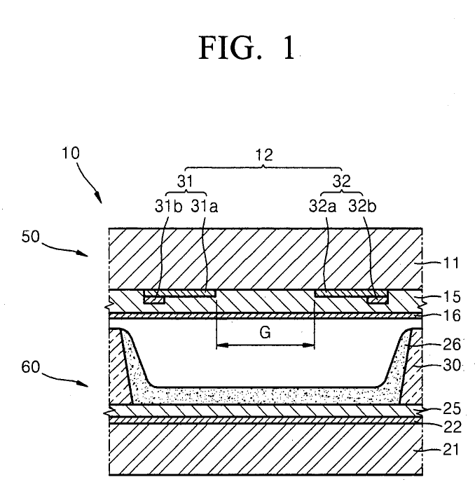

FIG. 1 is an exploded perspective view of a three-electrode surface discharge AC PDP 10. Referring to FIG. 1, the PDP 10 includes an upper panel 50 and a lower panel 60 that is combined with the upper panel 50 to be in parallel with the upper panel 50. A plurality of pairs of sustain electrodes 12, each including an X electrode 31 and a Y electrode 32, are located on a first substrate 11 of the upper panel 50, and address electrodes 22 are formed on a second substrate 21 of the lower panel 60, which faces the first substrate 11, to intersect the X electrodes 31 and the Y electrodes 32. Each X electrode 31 includes a transparent electrode 31a and a bus electrode 31b, and each Y electrode 32 includes a transparent electrode 32a and a bus 2 electrode 32b. A space where a pair of the X and Y electrodes 31 and 32 intersect the address 3 electrode 22, is used as a unit discharge cell. A first dielectric layer 15 is formed on a surface 4 of the first substrate 11 and a second dielectric layer 25 is formed on a surface of the second substrate 21 so as to bury, i.e.—cover, all of the electrodes formed on the respective substrates. A protective layer 16, which is generally formed of MgO, is disposed on the first dielectric layer 15. A barrier rib structure 30 is formed to cover part of the surface of the second dielectric layer 25 to maintain a discharge distance and prevent electrical and optical cross-talk between discharge cells. Phosphor layers 26 are applied on both sidewalls of the barrier rib structure 30 and the remaining part of the surface of the second dielectric layer 25.

In the above PDP 10, the greater the distance G between the X electrode 31 and the Y electrode 32, the more the distances between the X electrode 31 and the address electrode 22 and between the Y electrode 32 and the address electrode 22 approximate the distance G between the X electrode 31 and the Y electrode 32. Thus, during a discharge, a diffusion discharge occurs among the three electrodes 22, 31, and 32, which causes the discharge to spread to both the upper and lower panels 50 and 60, thereby improving the luminous efficiency. Accordingly, the distance G between the X electrode 31 and the Y electrode 32 must be increased to increase the luminous efficiency, which means that a driving voltage must also be increased.

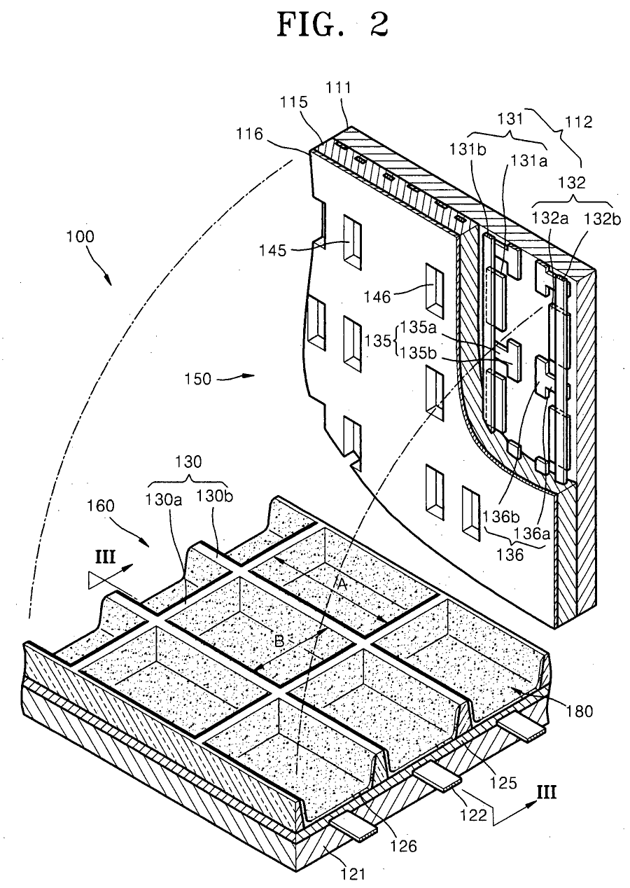

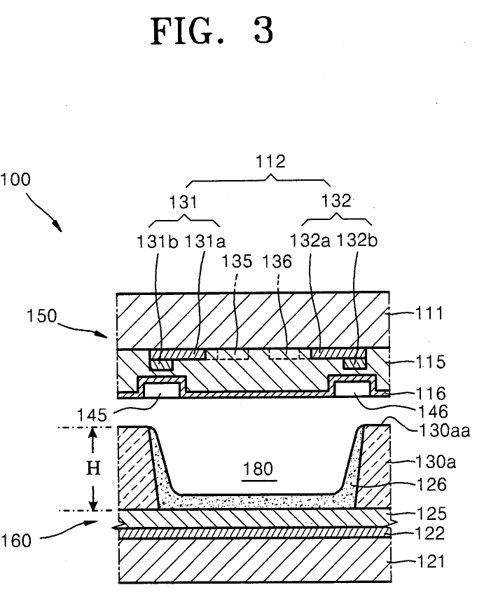

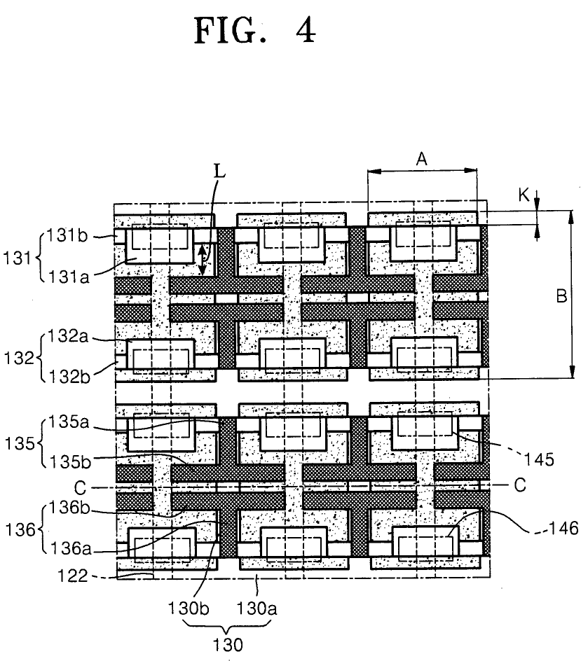

FIGS. 2 through 4 are views of a PDP 100 according to an embodiment of the present invention. FIG. 2 is an exploded perspective view of the internal structure of the PDP 100. FIG. 3 is a cross-sectional view of the PDP 100, taken along the line III-III. FIGS. 4 through 6 are layouts of the locations of discharge cells 180, electrodes 131, 132, and 122, and first and second grooves 145 and 146 of the PDP 100 of FIG. 2.

The PDP 100 of FIGS. 2 through 4 includes an upper panel 150 and a lower panel 160. The upper panel 150 includes a first substrate 111, a first dielectric layer 115, pairs of sustain electrodes 112, and a protective layer 116. The lower panel 160 includes a second substrate 121, a plurality of address electrodes 122, a second dielectric layer 125, a barrier rib structure 130, and phosphor layers 126.

The first and second substrates 111 and 121 are arranged to be spaced a predetermined distance apart from each other. A discharge space in which a discharge occurs is defined between the first and second substrates 111 and 121. The first and second substrates 111 and 121 are preferably formed of glass having good transmittivity of visible light rays. However, one of or both the first and second substrates 111 and 121 can be colored.

The barrier rib structure 130 is located between the first and second substrates 111 and 121. More specifically, the barrier rib structure 130 is located on the second dielectric layer 125. The barrier rib structure 130 divides the discharge space into a plurality of discharge cells 180, and prevents optical or electrical cross-talk from occurring between the discharge cells 180.

Referring to FIGS. 2 and 3, the barrier rib structure 130 divides the discharge space into the discharge cells 180 each having a rectangular cross-section. The barrier rib structure 130 includes first partitions 130a that are arranged substantially in parallel with the pairs of the sustain electrodes 112, and second partitions 130b that connect the first partitions 130a together. Thus, each of the discharge cells 180 is encompassed by a pair of facing first partitions 130a and a pair of facing second partitions 130b, and thus, the barrier rib structure 130 has a closed structure. However, the present invention is not limited to the above description. The barrier rib structure 130 can have a closed structure including discharge cells 180 each having a polygonal cross-section, such as a triangle or a pentagon, a circle, or an oval, or have an open structure in which the discharge cells 180 are formed in stripes.

Each discharge cell 180 has short sides B parallel to a direction in which the pairs of the sustain electrodes 112 extend, and long sides A perpendicular to the sustain electrodes 112.

The pairs of the sustain electrodes 112 are located on the first substrate 111 facing the second substrate 121. Each pair of the sustain electrodes 112 is a pair of X and Y electrodes 131 and 132 formed on the rear surface of the first substrate 111 to generate a sustain discharge. The pairs of sustain electrodes 112 are arranged in parallel on the first substrate 111 and spaced a predetermined interval apart from each other.

Each pair of sustain electrodes 112 includes the X electrode 131 acting as a common electrode and the Y electrode 132 acting as a scan electrode. In the present embodiment, the pairs of sustain electrodes 112 are formed directly on the first substrate 111. However, the location of the pairs of the sustain electrodes 112 is not limited thereto. For example, the pairs of sustain electrodes 112 can be arranged at predetermined intervals in a direction from the first substrate 111 to the second substrate 121.

The greater the distance G between the X electrode 131 and the Y electrode 132, the more the distances between the X electrode 131 and the address electrode 122 and between the Y electrode 132 and the address electrode 122 approximate the distance G between the X electrode 131 and the Y electrode 132. Thus, during a discharge, a diffusion discharge occurs among the three electrodes 131, 132, and 122, which causes the discharge to spread to both the upper and lower panels 50 and 60, thereby improving the luminous efficiency. Accordingly, the distance G between the X and Y electrodes 131 and 132 must be increased to improve the luminous efficiency.

However, an increase in the distance G between the X and Y electrodes 131 and 132 results in an increase in driving voltage. That is, the greater the distance G between the X and Y electrodes 131 and 132, the less the amount of electric charges accumulated between the X and Y electrodes 131 and 132 if the supplied voltage is fixed, thereby degrading capacitance. Therefore, a high sustain voltage must be supplied to activate a discharge between the X and Y electrodes 131 and 132.

As described above, in the present embodiment, in order to increase the luminous efficiency using a long gap, the distance G between the X electrode 131 and the Y electrode 132 is higher than the height H of the barrier rib structure 130. In this case, for example, the distance G between the X electrode 131 and the Y electrode 132 can be in a range of from 110 μm to 260 μm in order to prevent the need for the driving voltage to be increased beyond a predetermined voltage, e.g., about 300 V. The distance G between the X and Y electrodes 131 and 132 can range from a quarter to half of the length of the long side A of the discharge cell 180.

The X electrode 131 includes a transparent electrode 131a and a bus electrode 131b, and the Y electrode 132 includes a transparent electrode 132a and a bus electrode 132b. The transparent electrodes 131a and 132a are formed of a transparent material that is a conductor that generates a discharge and does not prevent light emitted from the phosphor layer 126 from being transmitted to the first substrate 111. The transparent material can be Indium Tin Oxide (ITO). However, when the transparent electrodes 131a and 132a are formed of ITO, a large voltage drop occurs in the lengthwise direction of the transparent electrodes 131a and 132a, thus consuming a large amount of driving power and degrading a response speed. To solve these problems, the bus electrodes 131b and 132b are formed of a metal having a narrow width on the transparent electrodes 131a and 132a. The bus electrodes 131b and 132b can be formed of metal, such as Ag, Al, or Cu in a single-layer structure, but can also be formed in a multi-layer structure. Photoetching or photolithography is used to fabricate the transparent electrodes 131a and 132a and the bus electrodes 131b and 132b.

Auxiliary electrodes 135 and 136 are respectively connected to the transparent electrodes 131a and 132a or the bus electrodes 131b and 132b. The auxiliary electrodes 135 and 136 respectively extend from the bus electrodes 131b and 132b (or the transparent electrodes 131a and 132a) toward the center of the discharge cell 180. The auxiliary electrodes 135 and 136 respectively include extensions 135a and 136a that extend from the bus electrodes 131b and 132b both over and along the barrier rib structure 130 and in parallel with the address electrodes 122, and protrusions 135b and 136b that protrude from one end of the extensions 135a and 136a and toward the center of the discharge cell 180. The extensions 135a and 136a protrude toward the center of the discharge cell 180 to be longer in the direction of the address electrodes 122 than the transparent electrodes 131a and 132a. The protrusions 135b and 136b are located between a pair of the transparent electrodes 131a and 132a that face each other.

In particular, the extensions 135a and 136a are located over the barrier rib structure 130 to control the amount of discharge current, thereby lengthening the lifetime of electrode. The protrusions 135b and 136b, acting as an igniter, respectively protrude from the first ends of the extensions 135a and 136a and branch out toward the centers of a pair of the adjacent discharge cells 180 in the direction of the bus electrodes 131b and 132b.

The first dielectric layer 115 is formed on the first substrate 111 to bury the pairs of the sustain electrodes 112. The first dielectric layer 115 prevents the adjacent X electrodes and Y electrodes 132 from being electrically connected to each other, and prevents charged particles or electrons from colliding against one another, thereby protecting the X and Y electrodes 131 and 132. Also, the first dielectric layer 115 induces electric charges.

The first dielectric layer 115 is covered with the protective layer 116. The protective layer 116 prevents charged particles and electrons from colliding against the first dielectric layer 115 during a discharge, thereby protecting the first dielectric layer 115. Also, the protective layer 116 discharges a large number of secondary electrons to make a plasma discharge occur smoothly during a discharge. To this end, the protective layer 116 is formed of a material that has a high coefficient of discharging secondary electrons and high transmittivity of visible light. The protective layer 116 is generally fabricated using sputtering or electron beam deposition after formation of the first dielectric layer 115.

The address electrodes 122 are arranged on the second substrate 121 facing the first substrate 111. The address electrodes 122 extend across the discharge cells 180 to intersect the X and Y electrodes 131 and 132.

The address electrodes 122 are used to generate an address discharge to facilitate a sustain discharge between the X and Y electrodes 131 and 132, and more particularly, to lower the voltage needed to generate the sustain discharge. An address discharge occurs between the Y electrode 132 and the address electrode 132.

The second dielectric layer 125 is formed on the second substrate 121 to bury the address electrodes 122. The second dielectric layer 125 is formed of a dielectric that can protect the address electrodes 122 by preventing charged particles or electrons from colliding against the address electrodes 122, and that induces electric charges during a discharge. The dielectric can be made of Bi2O3-B2O3-ZnO.

The red, green, and blue light emitting phosphor layers 126 are arranged on both sidewalls of the barrier rib structure 130 on the second dielectric layer 125, and the entire surface of the second dielectric layer 125 on which the barrier rib structure 130 is not formed. The phosphor layers 126 contain a material that receives ultraviolet light and generates visible light. Specifically, the phosphor layer 126 formed in the discharge cell 180 that emits red light contains a phosphor such as Y(V,P)O₄:Eu, the phosphor layer 126 formed in the discharge cell 180 that emits green light contains a phosphor such as Zn₂SiO₄:Mn, YBO₃:Tb, and the phosphor layer 126 formed in the discharge cell 180 that emits blue light contains a phosphor such as BAM:Eu.

Also, the discharge cells 180 are filled with a discharge gas that is a mixture of Ne, Xe, and the like. The first and second substrates 111 and 121 are sealed together via a sealing means, such as frit glass, which is coated on the edges of the first and second substrates 111 and 121, while the discharge cells 180 are filled with the discharge gas.

The shapes and arrangement of the X electrode 131, the Y electrode 132, and the auxiliary electrodes 135 and 136 are described in greater detail with reference to FIG. 4. The bus electrodes 131b and 132b extend toward the center of the discharge cell 180 and are spaced a predetermined interval K from the first partitions 130a.

As described above, the bus electrodes 131b and 132b are electrically connected to the transparent electrodes 131a and 132a. The transparent electrodes 131a and 132a, which are formed to a rectangular shape, are discontinuously arranged in each discharge cell 180. One side of each of the transparent electrodes 131a and 132a are respectively connected to the bus electrodes 131b and 132b and the other side of each of the transparent electrodes 131a and 132a faces the center of the discharge cell 180.

Also, the bus electrodes 131b and 132b are connected to the auxiliary electrodes 135 and 136, and the auxiliary electrodes 135 and 136 are located between the transparent electrodes 131a and 132a. Hereinafter, the auxiliary electrodes 135 and 136 will be referred to as the first and second auxiliary electrodes 135 and 136. The first auxiliary electrode 135 includes the first extension 135a and the first protrusion 135b, and the second auxiliary electrode 136 includes the second extension 136a and the second protrusion 136b.

One end of the first extension 135a formed on the second partition 130b is connected to the first bus electrode 131b and the other end is connected to the first protrusion 135b. The first protrusion 135b is formed in parallel with the first bus electrode 131b and spaced a predetermined distance L from the first bus electrode 131b. One end of the second extension 136a formed on the second partition 130b is connected to the second bus electrode 132b and the other end is connected to the second protrusion 136b. The second protrusion 136b is formed in parallel with the second bus electrode 132b and spaced the predetermined distance L from the second bus electrode 132b. Each pair of the first and second auxiliary electrodes 135 and 136 face each other.

The first and second protrusions 135b and 136b that face each other act as an igniter to start a discharge, and the discharge diffuses to the sustain electrodes 112 in which a discharge mainly occurs. Whether the first and second extensions 135a and 136a participate in a discharge is determined by the locations of the first and second extensions 135a and 136a. The above arrangement of the first and second auxiliary electrodes 135 and 136 lowers the driving voltage and improves discharge efficiency.

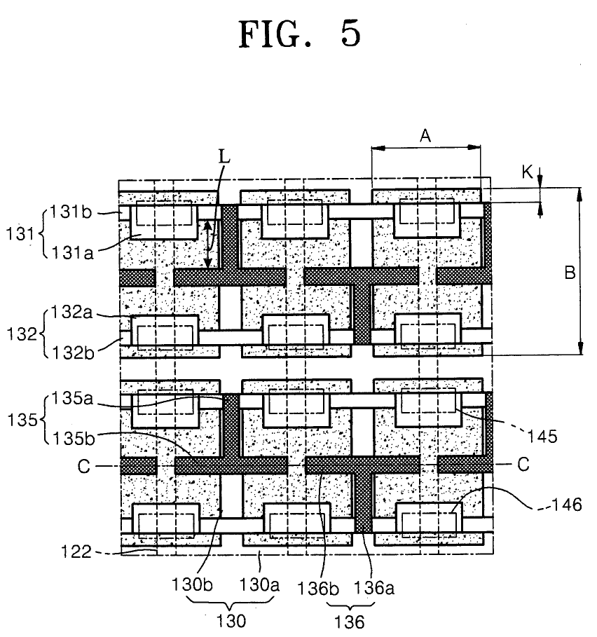

FIG. 5 is a layout of the locations of discharge cells, electrodes, and first and second grooves of a PDP according to another embodiment of the present invention. The PDP of FIG. 5 includes an X electrode 131, a Y electrode 132, and first and second auxiliary electrodes 135 and 136 whose shapes and arrangement are different than those of the PDP 100 of FIGS. 2 through 4.

The first and second auxiliary electrodes 135 and 136 of FIG. 5 are alternately arranged on a second partition 130b, unlike those of the PDP 100 of FIG. 4. In FIG. 5, first and second protrusions 135b and 136b that are alternately arranged act as an igniter to start a discharge, and the discharge diffuses to sustain electrodes 112 in which a discharge mainly occurs. The above arrangement of the first and second auxiliary electrodes 135 and 136 lowers the driving voltage and improves discharge efficiency.

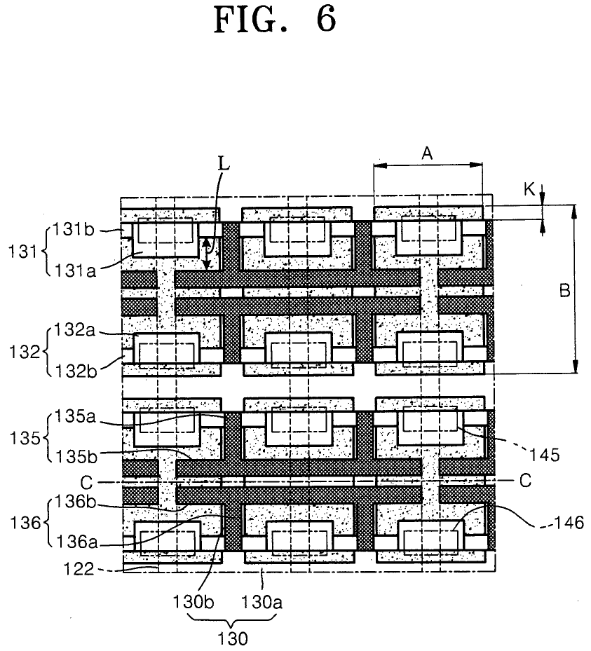

FIG. 6 is a layout of the locations of discharge cells, electrodes, and first and second grooves of a PDP according to another embodiment of the present invention. The PDP of FIG. 6 includes an X electrode 131, a Y electrode 132, and first and second auxiliary electrodes 135 and 136 whose shapes and arrangement are different than those of the PDP 100 of FIGS. 2 through 4.

The first and second auxiliary electrodes 135 and 136 of FIG. 6 include first and second extensions 135a and 136a and first and second protrusions 135b and 136b that form first and second closed loops. Each pair of the first and second auxiliary electrodes 135 and 136 face each other. One end of each of a pair of the first extensions 135a formed on a pair of second partitions 130b are connected to a first bus electrode 131b, and the other ends are connected to the first protrusion 135b. The first protrusion 135b is formed in parallel with the first bus electrode 131b and spaced a predetermined distance L from the first electrode 131b. A pair of the first extensions 135a, and the first protrusion 135b connected thereto form a first closed loop. One end of each of a pair of the second extensions 136a formed on a pair of the second partitions 130b are connected to a second bus electrode 132b, and the other ends are connected to the second protrusion 136b. The second protrusion 136b is formed in parallel with the second bus electrode 132b and spaced a predetermined distance L from the second bus electrode 132b. A pair of the second extensions 136a and the second protrusion 136b connected thereto form a second closed loop. In FIG. 6, the facing first and second protrusions 135b and 136b that respectively form the first and second closed loops act as an igniter to start a discharge, and the discharge diffuses to sustain electrodes 112 in which a discharge mainly occurs. The above arrangement of the first and second auxiliary electrodes 135 and 136 lowers the driving voltage and improves discharge efficiency.

First grooves 145 and second grooves 146 are formed in the first dielectric layer 115. The first and second grooves 145 and 146 are formed in the first dielectric layer 115 to a predetermined depth. The predetermined depth of the first and second grooves 145 and 146 is determined to be within a range in which the plasma discharge does not damage the first dielectric layer 115, and in consideration of the arrangement of wall charges and the magnitude of discharge voltage.

In each discharge cell 180, one of the first grooves 145 and one of the second grooves 146 are formed to correspond to each other. The first and second grooves 145 and 146 reduce the thickness of the first dielectric layer 115, thus improving the transmittivity of visible light. The first and second grooves 145 and 146 have a square or essentially square cross-section. However, they are not limited thereto. The first and second grooves 145 and 146 are preferably symmetrical with respect to a virtual, symmetrical surface C-C of the X and Y electrodes 131 and 132.

The first groove 145 extends beyond the first bus electrode 131b and includes part of an edge of the first transparent electrode 131a of the X electrode 131 and part of the first bus electrode 131b. The second groove 146 also extends beyond the second bus electrode 132b and includes part of an edge of the second transparent electrode 132a of the Y electrode 132 and part of the second bus electrode 132b. However, the first groove 145 is not limited to the above description. For example, the first groove 145 can be formed to correspond to only the first transparent electrode 131a or only a part of the first bus electrode 131b, or formed in a region that does not correspond to the X electrode 131. Also, the second groove 146 is not limited to the above description.

The first and second grooves 145 and 146 can be formed by using various methods. For example, they can be formed by applying a dielectric onto the first substrate 111 and etching the resultant structure. This method is preferable since it is simple to perform and incurs low manufacturing costs. However, a PDP is generally fabricated using a dielectric composed of PbO—B₂O₃—SiO₂ (lead borosilicate), which is a Pb-based material. The dielectric contains more than a desired amount of a SiO₂ component in order to control dielectric constant permittivity, thermal expansivity, and a reaction with a bus electrode. However, the dielectric contains Pb and thus is harmful to the human body. To solve this problem, it is preferable that the first dielectric layer 115 contains a Bi-based material and the Bi-based material contains Bi₂O₃. Thus, it is more preferable that the dielectric layer 115 is composed of Bi₂O₃-B₂O₃-ZnO.

The operation of the above PDP 100 according to an embodiment of the present invention is as follows.

Driving of the PDP 100 can be roughly divided into a reset period, a scan period, and a sustain period. In the reset period, wall charges of all of the discharge cells 180 are adjusted to the same level. In the scan period, one of the discharge cells 180, which is to be displayed, is selected. When a scan pulse voltage and a regular address voltage are supplied to the selected discharge cell 180, wall charges are accumulated in the selected discharge cell 180. In the sustain period, a discharge is maintained in the discharge cell 180 selected in the scan period. When a sustain pulse voltage is alternately supplied to each one of a pair of the sustain electrodes 112, a display discharge occurs.

In the scan period, since the distances between the first auxiliary electrode 135 and the address electrode 122 and between the second auxiliary electrode 136 and the address electrode 122 are shorter than the distance between the Y electrode 132 and the address electrode 122, a discharge first occurs in the address electrode 122 and the first and second auxiliary electrodes 135 and 136. Thus, it is possible to lower the address voltage by reducing a discharge gap in the scan period, thereby allowing a stable discharge in the scan period.

In the sustain period, a discharge starts in a short discharge gap between the first and second auxiliary electrodes 135 and 136. The discharge starting in the first and second auxiliary electrodes 135 and 136 diffuses to a comparatively long gap between the sustain electrodes 112 in which a discharge mainly occurs, thereby lowering the driving voltage and improving discharge efficiency.

Also, in the sustain period, electric fields are concentrated in the first and second grooves 145 and 146 in the first dielectric layer 115, thus reducing the discharge voltage. This phenomenon occurs because a discharge path between the X and Y electrodes 131 and 132 is reduced, a strong electric field is generated in the discharge path, thus causing concentration of electric fields, and the densities of electric charges and charged particles are high.

When the energy level of a discharge gas excited during a sustain period is lowered, ultraviolet light is emitted. The phosphor layer 126 applied in the discharge cell 180 is excited by the emitted ultraviolet light, and the energy level of the excited phosphor layer 126 is lowered to emit visible light. When the visible light penetrates the first dielectric layer 115 and the first substrate 111, an image that a user can recognize is formed.

A PDP according to the present invention is capable of lowering the driving voltage and significantly improving discharge efficiency.

While the present invention has been particularly shown and described with reference to exemplary embodiments thereof, it will be understood by those skilled in the art that various modifications in form and detail can be made therein without departing from the spirit and scope of the present invention as defined by the appended claims.

What is claimed is:

1. A Plasma Display Panel (PDP), comprising:
a first substrate and a second substrate facing each other;
a barrier rib structure arranged between the first and second substrates to define a plurality of discharge cells;
pairs of sustain electrodes arranged on the first substrate so as to face the second substrate and so that the sustain electrodes in each pair are spaced apart from one another, each pair of the sustain electrodes including an X electrode and a Y electrode, wherein a distance between the X and Y electrodes is greater than a height of the barrier rib structure;
a plurality of auxiliary electrodes protruding from the respective sustain electrodes in each pair of sustain electrodes toward the other sustain electrode of the pair of sustain electrodes; and
a first dielectric layer covering the pairs of sustain electrodes and the auxiliary electrodes, the first dielectric layer including at least two grooves arranged in each of the discharge cells, the at least two grooves corresponding to the X and Y electrodes.

2. The PDP of claim 1, wherein the barrier rib structure comprises:
first partitions extending in parallel with the pair of the sustain electrodes; and
second partitions connecting the first partitions to one another.

3. The PDP of claim 2, wherein each of the X and Y electrodes comprises a bus electrode and a transparent electrode arranged on the bus electrode, and wherein each of the auxiliary electrodes comprises a protrusion arranged in parallel with either the bus electrode or the transparent electrode and an extension arranged on a respective second partition, the extension connecting the protrusion to either the bus electrode or the transparent electrode.

4. The PDP of claim 3, wherein the protrusions of the auxiliary electrodes face one another.

5. The PDP of claim 3, wherein the auxiliary electrodes are alternately arranged on the second partitions.

6. The PDP of claim 3, wherein the protrusions of the auxiliary electrodes are parallel to one another.

7. The PDP of claim 6, wherein the auxiliary electrodes are alternately arranged on the second partitions.

8. The PDP of claim 2, wherein each of the X and Y electrodes comprises a bus electrode and a transparent electrode arranged on the bus electrode, and wherein each of the auxiliary electrodes comprises a protrusion arranged in parallel with either the bus electrode or the transparent electrode and a extension connecting the protrusion to either the bus electrode or the transparent electrode, either the bus electrode or the transparent electrode forming a closed loop together with the respective protrusion and extension.

9. The PDP of claim 2, wherein each of the X and Y electrodes is arranged to correspond to the first partitions.

10. The PDP of claim 2, wherein each of the X and Y electrodes comprises a bus electrode and a transparent electrode arranged on the bus electrode, the bus electrodes being arranged between the first partitions to correspond to the discharge cells.

11. The PDP of claim 1, wherein the grooves comprise a groove corresponding to the X electrode and a groove corresponding to the Y electrode in each discharge cell.

12. The PDP of claim 11, wherein the distance between the grooves is equal to or greater than a distance between the X and Y electrodes, and is less than or equal to a distance between farthest ends of the X and Y electrodes.

13. The PDP of claim 11, wherein each of the X and Y electrodes comprises a bus electrode and a transparent electrode arranged on the bus electrode, the grooves being arranged to correspond to the transparent electrodes.

14. The PDP of claim 11, wherein each of the X and Y electrodes comprises a bus electrode and a transparent electrode arranged on the bus electrode, at least parts of the grooves being arranged to correspond to the bus electrodes.

15. The PDP of claim 1, wherein the grooves in each discharge cell are symmetrical with respect to a plane perpendicular to the first substrate and equidistant from the X and Y electrodes in the discharge cell.

16. The PDP of claim 1, further comprising:
address electrodes intersecting the pairs of the sustain electrodes, the address electrodes arranged on the second substrate;
a second dielectric layer covering the address electrodes; and
phosphor layers arranged in the discharge cells.
